(19) United States
(12) Patent Application Publication
(10) Pub. No.: US 2007/0198683 A1
(43) Pub. Date: Aug. 23, 2007

(54) Information publication control method and apparatus, and information publication control instruction method, and apparatus

(75) Inventors: Tomoya Iwakura, Kawasaki (JP); Fumihito Nishino, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/443,129

(22) Filed: May 31, 2006

(30) Foreign Application Priority Data
Feb. 22, 2006 (JP) 2006-044667

(51) Int. Cl. G06F 15/173

(52) U.S. Cl. 709/223

(57) ABSTRACT

An object of the present invention is to carry out publication control for a portion of contents according to its valid period. This invention includes: reading out publication data including first data whose publication should be controlled, publication control condition data relating to a valid period of the first data, and second data whose publication does not have to be controlled from a publication data storage storing the publication data to judge whether or not a condition defined in the publication control condition data is satisfied; and upon detecting that the condition defined in the publication control condition data is satisfied, generating current publication data including the first data corresponding to the publication control condition data whose condition is judged to be satisfied and the second data and outputting the generated current publication data. In this way, when the publication of the first data is controlled based on the publication control condition data concerning the valid period, it becomes possible to control not to open information whose validity has been lost such as the contact telephone number to inquire the event, to the public, for example, after the event ended or the like.

### TECHNICAL FIELD OF THE INVENTION

The present invention relates to a technique for controlling publication of only a portion of contents.

### BACKGROUND OF THE INVENTION

In the Internet, various information (i.e. contents) is opened to the public on Web pages. When such contents in the Internet indicate, for example, an event holding notification, the period until the event ends is an original valid period of the contents. However, even if this original valid period has passed, the effectiveness of the contents is not always lost. Specifically, the contents concerning such a past event are very useful for an information user who investigates the past events. In this way, the contents in the Internet can be continuously used via search engines, if they are opened, and have high effectiveness for the information users. In addition, from a viewpoint of the customer service and/or the publication of the activity history, it may be reasonable for informants to continuously open the contents to the public.

However, in the case of the aforementioned example of the contents concerning the event, when the publication of the contents continues after the event ends, problems may occur. For example, when the contents include a contact telephone number to inquire the event, the disarray is caused by information users who call the contact telephone number after the event ends. The contents concerning subjects other than the event may also have a problem for the telephone number and/or other personal information included in a portion of the contents although there is no problem for almost all portions of the contents. Because of the workload cost, the countermeasure to avoid the occurrence of such a problem was only to stop the presentation of the entire contents, until now.

Incidentally, for example, JP-A-3-163660 discloses a following technique. Specifically, a computer according this technique has a display device, an input device, and a processor to execute a spreadsheet program. Then, the spreadsheet program displays plural columns and rows crossing each other. In addition, a certain row among the plural rows has a predetermined relation with another row, and the predetermined relation is domination or subordination. Then, a method for hiding a selected row among the plural rows includes a) automatically identify a dominant row having a dominant relation against at least one subordinate row; b) automatically selecting at least one subordinate row having a subordinate relation against the dominant row; and c) by hiding at least one selected subordinate row, avoiding displaying at least one subordinate row on a display device. As described above, although a construction where a portion of structured data like the spreadsheet is hidden is disclosed in this publication, there is no consideration for hiding a portion of unstructured data. In addition, this publication assumes the dominant or subordinate relation. This dominant or subordinate relation is easily defined because the structured data like the spreadsheet is handled. Furthermore, any resolving method against the aforementioned problem is not indicated.

Furthermore, EP-1072981-A2 discloses a technique for setting a concealed portion of information by the informant of this information when communicating this information, specifically, for preventing from being viewed from third party other than the informant when the creator or viewers of this information output this information. More specifically, the technique has a device information storage storing device information including either a type of a document processing device or a utilization environment thereof; a concealment processor that carries out the concealment processing to conceal a specific portion of input document information; and a controller that causes the concealment processor to operate based on the device information stored in the device information storage and controls it to output the document information. This device information storage stores the device information according to its categorization, and the concealment processor sets a category to a specific portion of the document information according to contents of the specific portion, compares the category of the device information with the category of the specific portion to judge, based on the comparison result, whether or not the concealment processing should be carried out. In this way, although the concealment is controlled according to the device information including either the type of the document processing device or the utilization environment thereof, it is determined whether or not the, concealment is carried out according to the informant side, and any resolving method for the aforementioned problem is not indicated. That is, the publication control is not carried out according to content of the contents.

As described above, conventionally, there is no disclosure for a viewpoint of the publication control according to content of the contents, specifically, according to the validity of content of data whose publication is controlled. More specifically, there is no disclosure for a viewpoint of the publication control according to the valid-period of content of data whose publication is controlled. Therefore, it is necessary to stop the publication of the entire contents when the valid period has passed or to modify the portion of the contents by spending time.

### SUMMARY OF THE INVENTION

Therefore, an object of the present invention is to provide a technique to control the publication of a portion of contents according to its valid period.

An information publication control method according to a first aspect of the present invention includes: reading out publication data including first data whose publication should be controlled, publication control condition data relating to a valid period of the first data, and second data whose publication does not have to be controlled from a publication data storage storing the publication data to judge whether or not a condition defined in the publication control condition data is satisfied; and upon detecting that the condition defined in the publication control condition data is satisfied, generating current publication data including the first data corresponding to the publication control condition data whose condition is judged to be satisfied and the second data and outputting the generated current publication data.

In this way, when the publication of the first data is controlled based on the publication control condition data concerning the valid period, it becomes possible to control not to open information whose validity has been lost such as the contact telephone number to inquire the event, to the public, for example, after the event ended or the like. Incidentally, the valid period is defined as a time period during which the data whose publication should be controlled is valid. Therefore, the valid period is indirectly defined. For example, the valid period represented by a weather state such as “during raining” may be defined.

In addition, the information publication control method may further include: extracting a character string whose publication should be controlled from text data to be published, which is designated by an informant, and storing the character string into a storage device. Thus, for instance, by analyzing the text data, personal information such as a unique noun, telephone number, or a specific kind of information to which the valid period can be set may be extracted.

Incidentally, the text data to be published may be text data having no structure in data itself. Because unstructured data is major in normal contents, it is very useful if the data whose publication should be controlled can be automatically extracted from such text data having no structure in data itself. In addition, in the text data to be published, the data whose publication should be controlled and the data whose publication does not have to be controlled may be mixed, or the data whose publication should be controlled may be separately designated by the informant.

Furthermore, the information publication control method may further include: presenting the character string stored in the storage device as candidate data to an informant; and identifying a candidate character string selected by the informant or a character string designated by the informant as the first data in the publication data, and storing the identified character string into the storage device. This is because there is a case where the data whose publication should be controlled cannot be appropriately extracted automatically without any mistake.

In addition, the information publication control method may further include: extracting a publication control condition character string corresponding to the first data from the text data to be published, and storing the extracted publication control condition character string into the storage device. For example, in the case of the contents concerning the event, because it is assumed that data concerning the event holding period is included, such data is extracted. Incidentally, as for the publication control condition character string, predetermined kinds of texts having a degree of association, which is equal to or more than a preset threshold, with the first data whose publication should be controlled, such as time, may be extracted.

Furthermore, the information publication control method may further include: presenting the publication control condition character string stored in the storage device as candidate data to the informant; and identifying candidate data selected by the informant or data designated by the informant as the publication control condition data in the publication data. This is because there is a case where the publication control condition data cannot be always extracted automatically. Incidentally, a set of the data whose publication should be controlled and the publication control condition data may be designated by the informant. There is a case where such plural sets of the data whose publication should be controlled and the publication control condition data are defined, and data whose corresponding condition is satisfied is opened to the public for each processing.

In addition, the information publication control method may further include: generating the publication data by assigning a tag for the publication control so as to associate the identified first data with the publication control condition data. By using such a tag when the current publication data is generated, an appropriate display may be carried out.

An information publication control instruction method according to a second aspect of the present invention includes: extracting a character string whose publication should be controlled from text data to be published, which is designated by an informant, and storing the extracted character string into a storage device; presenting the character string stored in the storage device as publication controlled candidate data to the informant; identifying the publication controlled candidate data designated by the informant or data designated by the informant as first data whose publication should be controlled; extracting a publication control condition character string corresponding to the first data and relating to a valid period from the text data to be published, and storing the publication control condition character string into the storage device; presenting the publication control condition character string stored in the storage device as condition candidate data to the informant; identifying the condition candidate data designated by the informant or data designated by the informant as publication control condition data; assigning a tag for publication control so as to associate the first data with the publication control condition data, and generating publication data including data whose publication does not have to be controlled and which is included in the text data and the tagged first data and publication control condition data, and storing the publication data into the storage. By carrying out such a processing, it becomes possible to appropriately generate publication data for which the publication control is carried out.

Incidentally, it is possible to create a program for causing a computer to execute the method according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a diagram to explain a system outline according to an embodiment of the present invention;

FIG. 2 is a diagram showing a publication data registration processing flow according to the embodiment of the present invention;

FIG. 3A is a diagram showing an example of text data, FIG. 3B and FIG. 3C are diagrams showing an example of data during the processing, FIG. 3D is a diagram showing an example of the publication data, FIG. 3E is a diagram showing a display example in a case where the publication control condition is satisfied, and FIG. 3F is a diagram showing a display example in a case where the publication control condition is not satisfied;

FIG. 4 is a diagram showing another example of the publication data registration processing flow according to the embodiment of the present invention;

FIG. 5A is a diagram showing an example of text data, FIG. 5B is a diagram showing an example of data during the processing, FIG. 5C is a diagram showing an example of the publication data, FIG. 5D is a diagram showing a display example in a case where the publication control condition is satisfied, and FIG. 5E is a diagram showing a display example in a case where the publication control condition is not satisfied;

FIG. 6 is a diagram showing a publication data reference processing flow according to the embodiment of the present invention;

FIG. 7 is a diagram to explain another system outline according to the embodiment of the present invention;

FIG. 8 is a diagram showing another embodiment of the Web browser;

FIG. 9 is a diagram showing another embodiment of the server;

FIG. 10A is a diagram showing the publication data according to another application example of the embodiment of the present invention, FIG. 10B is a diagram showing a display example in a case where the publication control condition is satisfied, and FIG. 10C is a diagram showing a display example in a case where the publication control condition is not satisfied;

FIG. 11A is a diagram showing the publication data according to another application example of the embodiment of the present invention, FIG. 11B is a diagram showing a display example in a case where the publication control condition is satisfied, and FIG. 11C is a diagram showing a display example in a case where the publication control condition is not satisfied;

FIG. 12 is a diagram showing another embodiment of the server; and

FIG. 13 is a functional diagram of a computer.

### DETAILED DESCRIPTION OF THE PREFERRED EMBODIMENTS

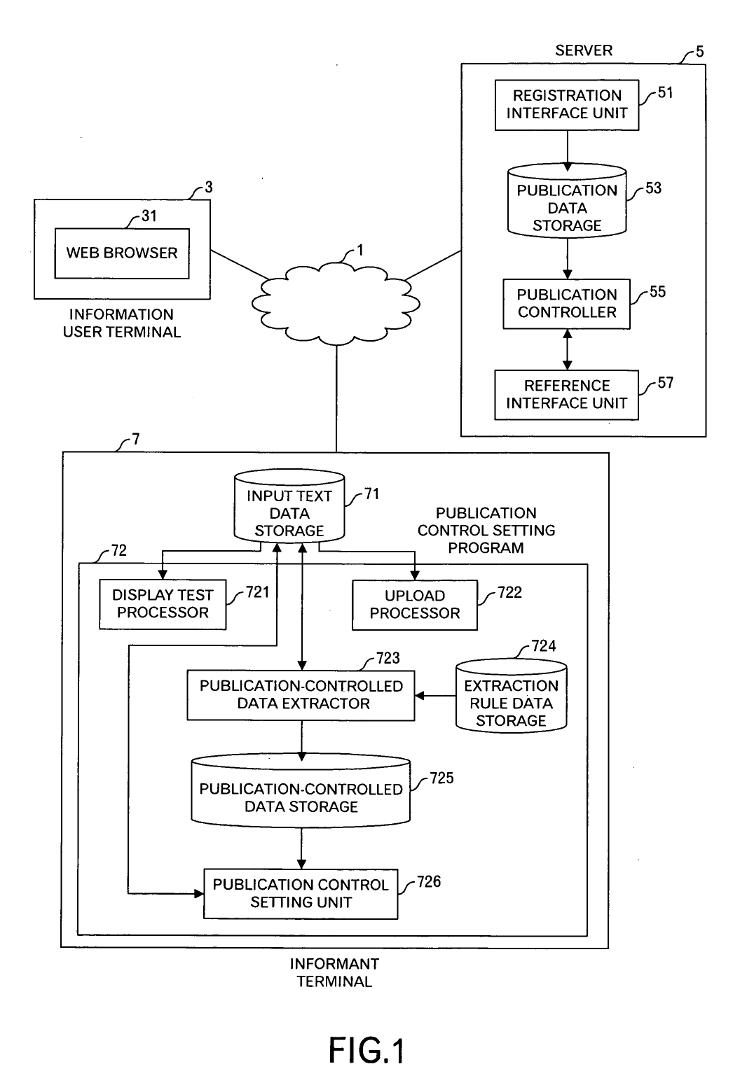

A system outline according to an embodiment of the present invention will be explained with reference to FIG. 1. For example, a network 1 such as the Internet is connected with one or plural information user terminals 3 that are personal computers, for example, and execute a Web browser 31, one or plural informant terminals 7 that are personal computers, for example, and have a document creation program (not shown), an input text data storage 71, and a publication control setting program 72, and one or plural servers 5 that store publication data received from the informant terminal 7, and transmit requested data in response to an access from the information user terminal 3.

The publication control setting program 72 of this informant terminal 7 has a publication-controlled data extractor 723 that reads out text data from the input text data storage 71 storing text data to be published, which is created by the document creation program such as a home page editor, and a normal editor, to carry out an extraction processing of data whose publication should be controlled and the like, an extraction rule data storage 724 storing data such as extraction rules and dictionaries, which are used by the publication-controlled data extractor 723 for the extraction processing of the data whose publication should be controlled, a publication-controlled data storage 725 storing the data whose publication should be controlled, which is extracted by the publication-controlled data extractor 723, a publication control setting unit 726 that extracts a publication control condition associated with the publication-controlled data stored in the publication-controlled data storage 725 from the text data stored in the input text data storage 71, and generates publication data by setting the publication control to the text data, a display test processor 721 that carries out an examination to confirm whether or not the publication control is carried out for the publication data stored in the input text data storage 71 according to the intention, and an upload processor 722 that uploads the publication data that is stored in the input text data storage 71 and to which the publication control setting is appropriately carried out.

In addition, the server 5 has a registration interface unit 51 that is an interface with the upload processor 722 of the publication control setting program 72 in the informant terminal 7, a publication data storage 53 storing the publication data registered via the registration interface unit 51, a reference interface unit 57 that accepts a request from the Web browser 31, for example, of the information user terminal 3, and a publication controller 55 that carries out a publication control processing for the publication data relating to the request and registered in the publication data storage 53 according to publication control settings for the data whose publication should be controlled, and generates current publication data.

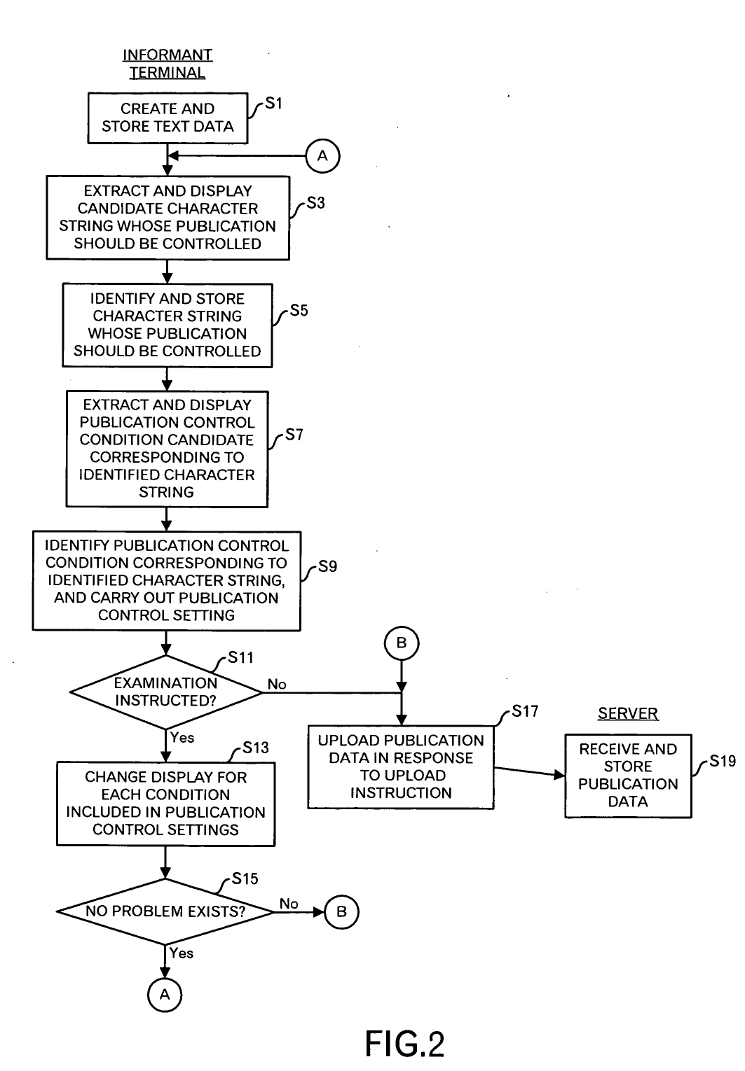

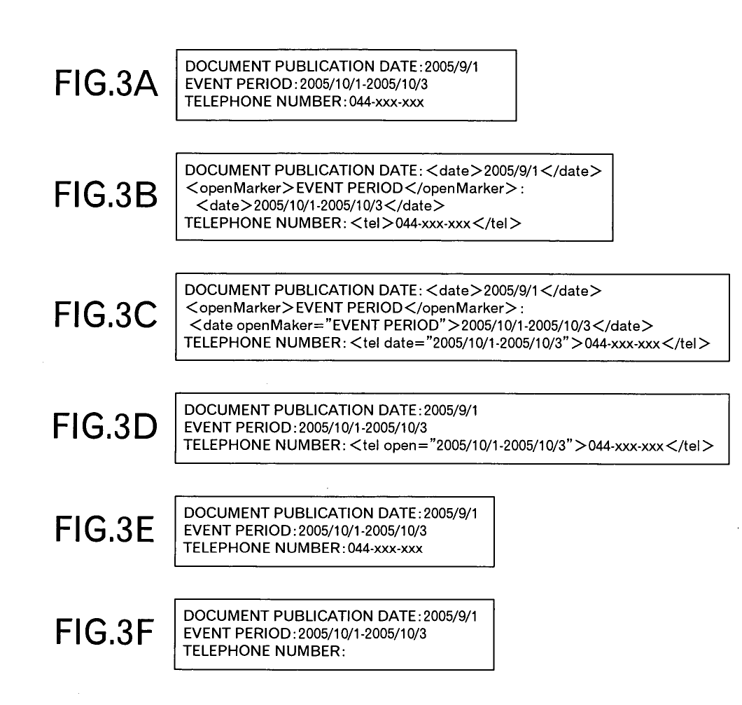

Next, a processing flow of the system shown in FIG. 1 will be explained with reference to FIG. 2 to FIG. 6. First, by using the document creation program or the like in the informant terminal 7 text data is created, and stored it into the input text data storage 71 (FIG. 2: step Si). For example, data as shown in FIG. 3A is created, and stored into the input text data storage 71. In an example of FIG. 3A, the text data includes a document publication date, an event period, and a telephone number. Incidentally, in the example of FIG. 3A, although, as display contents, data is indicated in correspondence with each item, the text data does not have any structure in which rows and columns are fixedly defined, for example. Namely, in this embodiment, the text data is not structured as data. In addition, although the text data is handled, data other than the text data may be included.

Next, the publication-controlled data extractor 723 of the publication control setting program 72 analyzes the text data stored in the input text data storage 71 with reference to the extraction rule data storage 724, extracts a character string whose publication should be controlled, and displays the character string as a candidate character string on a display device (step S3). For example, by using a technique of extracting the unique noun (for example, see Masayuki Asahara and Yuji Matsumoto, “Japanese named entity extraction with redundant morphological analysis”, In Proc. Human Language Technology and North American Chapter of Association for computational Linguistics (HLT-NAACL), pp. 8-15, May 2003), a character string that may be necessary for the publication control, such as a name of person, a name of place (specifically, an address), and a telephone number are extracted and displayed on the display device as the candidate character string. Incidentally, by using the person name dictionary and the place name dictionary that is stored into the extraction rule data storage 724 in advance, the name of person and name of place may be extracted. In addition, as a technique of extracting the telephone number in addition to the aforementioned method, a method of extracting it by implementing rules using a character string processing function by a regular expression in a language such as Perl and Rudy may be used. The rule may be “0&d{2}-&d{3}-&d{4}”, for example. Here, &d means that it matches any number, and the number between { and } represents the number of repeats. Therefore, by using the aforementioned rule, the number such as 044-0123-4678 can be extracted.

In the step S3, a character string to which a condition of the publication control should be set is extracted. In the following example, the extracted character string is designated by tags like <XXX> and </XXX>, and XXX represents an arbitrary character string to indicate the extracted item. In an example of FIG. 3A, the telephone number is extracted, and it is sandwiched by <tel> and </tel> tags. In addition, for the subsequent processing, a character string associated with the date is extracted and sandwiched by <date> and </date> tags. Furthermore, the character string representing the valid period or publication period is extracted and sandwiched by<openMarker> and </openMarker> tags. After that, the data sandwiched by <date> and <data> is associated with the data sandwiched by <openMarker> and </openMarker>. Then, the text data shown in FIG. 3A is converted into data shown in FIG. 3B. The data shown in FIG. 3B is stored into the input text data storage 71.

Incidentally, the informant may designate the type of the character string to be extracted to the publication-controlled data extractor 723, and the publication-controlled data extractor 723 may carry out the extraction processing according to the designated type of the character string. For example, the informant may designate the telephone number as the type or may designate the address as the type.

The informant selects an appropriate character string as a character string whose publication should be controlled among the candidate character strings displayed on the display device or designates a character string whose publication should be controlled by himself or herself. Incidentally, a character string whose publication should be controlled may be designated by himself or herself in addition to selecting an appropriate character string as a character string whose publication should be controlled among the candidate character strings. The number of character strings whose publication should be controlled may be one or plural. In addition, the character string whose publication should be controlled is not only the character string included in the text data stored in the input text data storage 71, and but also another character string may be additionally input.

The publication-controlled data extractor 723 identifies a character string whose publication should be controlled and which is used in the following processing, according to the instruction from the informant, and stores it into the publication-controlled data storage 725 (step S5). In the example of FIG. 3B, it is assumed that the telephone number sandwiched by <tel> and </tel> tags is identified as the data whose publication should be controlled.

Then, the publication control setting unit 726 extracts a candidate character string for the publication control condition corresponding to the character string whose publication should be controlled and which is stored in the publication-controlled data storage 725 from the text data stored in the input text data storage 71, and displays it on the display device (step S7). By using a well-known relation extraction technique (for example, see Dmitry Zelenko, Chinatsu Aone, and Anthony Richardella, “Kernel methods for relation extraction”, Association for Computational Lingui stics, Language Processing (EMNLP), Philadelphia, July 2002, pp. 71-78, Proceedings of the Conference on Empirical Methods in Natural), the publication control setting unit 726 identifies a candidate character string relating to a valid period or publication period having a degree of association, which is equal to or more than a predetermined threshold, with the character string whose publication should be controlled.

In the example of FIG. 3B, in order to identify the candidate character string relating to the valid period or publication period, “event period” is identified as a character string relating to a publication condition, and, furthermore, it is identified that “event period” relates to a character string “2005/10/1-2005/10/3” having an attribute of “date”, and “2005/10/1-2005/10/3” is identified as being the publication condition candidate. Then, as a character string having the attribute of “date” and having a degree of association, which is equal to or more than a predetermined reference, with the character string “telephone number” whose publication should be controlled, the character string “2005/10/1-2005/10/3” is extracted. In the example of FIG. 3B, after the character string relating to the publication condition and the publication condition candidate are identified, and associated, the result of the association and data whose publication should be controlled are associated. Therefore, the tree identifications of the character strings and two associations are carried out. However, the publication condition candidate and the data whose publication should be controlled may be directly associated.

The informant selects an appropriate character string among the candidate character strings relating to the publication control condition corresponding to the character string whose publication should be controlled, or designates a character string of the publication control condition by himself or herself.

Then, the publication control setting unit 726 identifies a character string relating to the publication control condition corresponding to the character string whose publication should be controlled according to the instruction from the informant, and carries out a publication control setting (step S9). Specifically, the character string whose publication should be controlled and the corresponding character string of the publication control condition are associated by tags and stored into the input text data storage 71.

In the example of FIG. 3B, it is identified for the character string “event period” that it directly relates to a character string “2005/10/1-2005/10/3” having the attribute of “date”, and attribute data of openMarker=“event period” is added to the tag <date> for “2005/10/1-2005/10/3”. In the subsequent examples, when a tag such as <date> has the attribute of the openMarker and its value, it is assumed that it is a tag relating to the publication control condition. Furthermore, the character string “2005/10/1-2005/10/3” is extracted as a character string having a degree of association, which is equal to or more than the predetermined reference, with the character string “044-xxx-xxx” whose publication should be controlled, and the attribute data of date=“2005/10/1-2005/10/3” is added to the tag <tel>. Then, data shown in FIG. 3C is generated and stored into the input text data storage 71.

Furthermore, when it is confirmed by the informant that the character string relating to the publication control condition is “2005/10/1-2005/10/3”, a tag <tag> including an open attribute is generated as the publication control setting data. In the subsequent examples, the open attribute is an attribute to set the publication control condition for the data whose publication should be controlled, and a condition whether or not it is published is designated by the attribute value. That is, “2005/10/1-2005/10/3” is set as the attribute value of the open attribute, and <tel open=“2005/10/1-2005/10/3> is registered. Incidentally, because other kinds of tags become unnecessary, they are deleted. That is, data as shown in FIG. 3D is generated and stored into the input text data storage 71.

When the processing until this stage is completed, the publication control setting that the telephone number “044-xxx-xxx” is published during “2005/10/1-2005/10/3” is already completed. Incidentally, although the processing is carried out in the aforementioned example after the informant confirmed, the processing until this stage may be carried out without any confirmation. In such a case, if the character string “event period” can be automatically recognized as the character string representing the valid period or publication period, the aforementioned tagging can be automatically carried out. Specifically, a tag including the character string “2005/10/1-2005/10/3” sandwiched by the date tags including the openMarker attribute as the attribute value of the date attribute is modified to the aforementioned form.

Then, the display test processor 721 judges whether or not an examination instruction is accepted from the informant (step S11). When the examination instruction is accepted from the informant, the display test processor 721 changes the display for each condition included in the publication control setting (the tag in the aforementioned example) (step S13). For example, assuming that the present time is within the period identified as the valid period or the publication period, the publication control condition is evaluated to display the data whose publication should be controlled and the data whose publication does not have to be controlled on the display device. For example, data as shown in FIG. 3E is displayed. In addition, assuming that the present time is outside the period identified as the valid period or the publication period, the publication control condition is evaluated to display the data whose publication does not have to be controlled but not to display the data whose publication should be controlled. For example, data as shown in FIG. 3F is displayed. Incidentally, it is possible to confirm whether or not the publication control is carried out according to the intention by designating arbitrary date and time, and displaying the contents in the case where the present time is the designated date and time.

Then, the informant confirms whether or not the control is carried out according to his or her intention. When the control is not carried out according to his or her intention, that is, the data whose publication should be controlled is displayed even if the time is outside the valid period or the data whose publication should be controlled is not displayed even if the time is within the valid period, the informant inputs an existence of a problem. The publication control setting program 72 accepts the input representing the existence of the problem (step S15: No route), and returns to the step S3 via a terminal A, for example, to retry the processing.

On the other hand, when the control is carried out according to his or her intention, the informant inputs no problem. The publication control setting program 72 accepts the input representing no problem (step S15: Yes route), the processing shifts to step S17 via a terminal B, for example. When the data whose publication should be controlled has no problem, the processing may return to the step S7.

In addition, when the informant does not instruct the examination at the step S11, it is assumed that the upload instruction is input in this embodiment. Therefore, the upload processor 722 uploads the publication data stored in the input text data storage 71 to the server 5 in response to the upload instruction (step S17). As described above, the publication data includes the tagged data whose publication should be controlled and publication control condition data and the data whose publication does not have to be controlled. The registration interface unit 51 of the server 5 carries out a necessary processing for the registration, such as the authentication of the informant terminal 7, and then, receives the publication data from the informant terminal 7 and stores it into the publication data storage 53 (step S19).

By carrying out such a processing, the data as shown in FIG. 3D is uploaded to the sever 5, and the publication control is carried out for a portion of the contents thereafter.

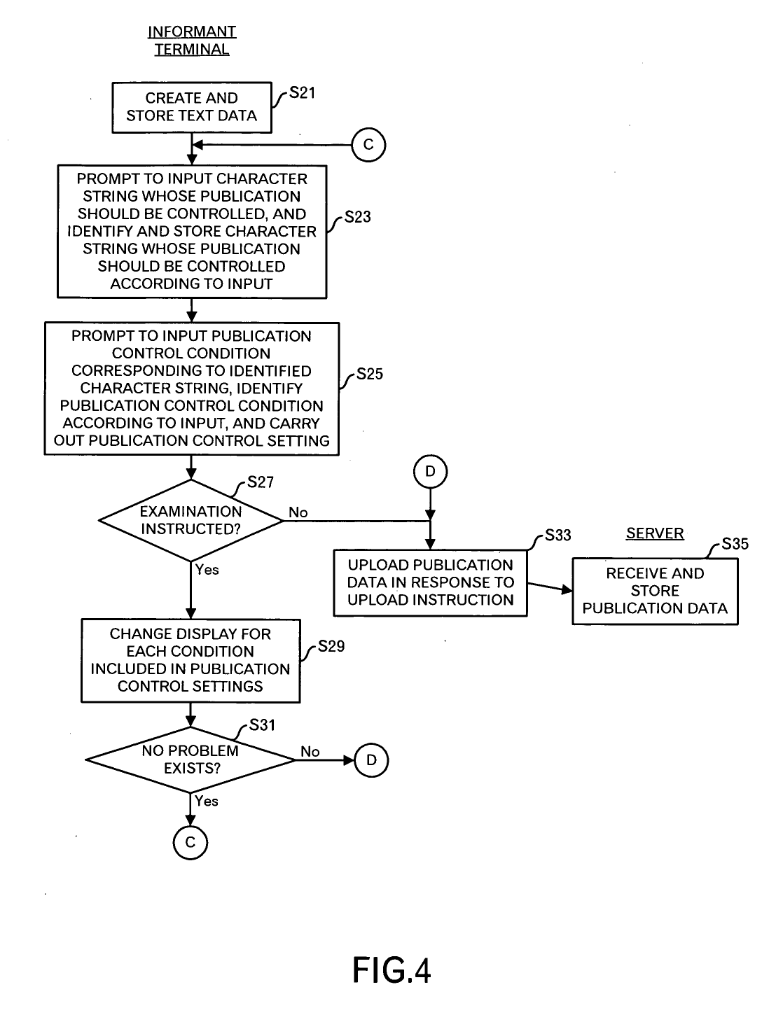

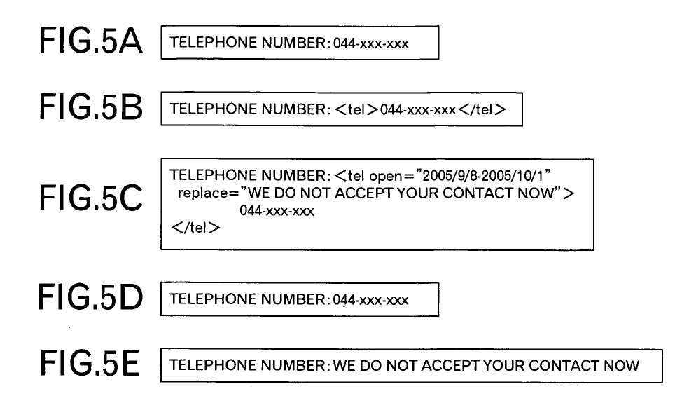

Incidentally, the processing to automatically extract the data whose publication should be controlled and the publication control condition data, basically, was described above. However, it is possible to carry out a following processing, for example. Namely, first, the informant creates text data by using the document creation program in the informant terminal 7 or the like, and stores it into the input text data storage 71 (FIG. 4: step S21). For example, the text data including character strings as shown in FIG. 5A is created and stored. Then, the publication-controlled data extractor 723 displays the text data stored in the input text data storage 71 on the display device, prompts the informant to input or designate a character string whose publication should be controlled, identifies the character string whose publication should be controlled according to the input or designation from the informant, and stores it into the publication-controlled data storage 725 (step S23). In the FIG. 5A, assuming the character string “044-xxx-xxx” is designated, the publication-controlled data extractor 723 identifies “044-xxx-xxx” designated by the informant, and sandwiches it between <tel> and </tel> tags as show in FIG. 5B, for example. There is a case where the informant designates that the character string is a telephone number.

Furthermore, the publication control setting unit 726 displays the text data stored in the input text data storage 71 on the display device, prompts the informant to input or designate the publication control condition corresponding to the character string whose publication should be controlled, and identifies the publication control condition according to the input or designation to carry out the publication control setting (step S25). For example, in the example of FIG. 5A, the input or designation of “2005/9/8-2005/10/1” that is a valid period or a publication period is carried out. Such a valid period or a publication period may be included in the text data. Here, settings other than the valid period or the publication period may further be designated at this stage. For example, as data to be published during a period outside the valid period or the publication period, data such as “We do not accept your contact now” is designated. Such data is not normally included in the text data, the informant has to input it intentionally. The publication control setting unit 726 accepts an input or designation from the informant, and sets an attribute to a <tel> tag by using setting data including the publication control condition and the like. Specifically, similar to FIG. 3D, an attribute value “2005/9/9-2005/10/1” is set to the open attribute, and an attribute value “We do not accept your contact now” is set to a replace attribute that causes to open it to the public during a period outside the valid period or the publication period. Then, data as shown in FIG. 5C is stored in the text data storage 71.

Incidentally, it is possible not to define the replace attribute as shown in the example of FIG. 3D. In addition, as for the data “We do not accept your contact now”, it may be designated in the step S23 as the character string whose publication should be controlled.

Although only the distinction between within or outside the valid period or publication period is described in the above example, plural valid periods or publication periods may be set. For example, a first period is defined by an attribute value of an open1 attribute, a character string sandwiched between the <tel> and </tel> tags is displayed during the period defined in the open1, a second period is defined by an attribute value of an open2 attribute, a character string defined by an attribute value of a replace1 attribute is displayed, and a message “We do not accept your contact now” defined by an attribute value of a replace2 attribute is further displayed during other period. Thus, plural sets of the character string whose publication should be controlled and the publication control condition may be defined.

Then, the display test processor 721 judges whether or not an examination instruction is accepted from the informant (step S27). When the examination instruction is accepted from the informant, the display test processor 721 changes the display for each condition (step S29). For example, assuming the present time is within the period identified as the valid period or publication period, the publication control condition is evaluated to display the data whose publication should be controlled and the data whose publication does not have to be controlled on the display. For example, data as shown in FIG. 5D is displayed. That is, the telephone number is displayed as it is. In addition, assuming the present time is outside a period identified as the valid period or the publication period, the publication control condition is evaluated not to display data whose publication should be controlled, and to display data whose publication does not have to be controlled. For example, data as shown in FIG. 5E is displayed. That is, “We do not accept your contact now” is displayed. Then, the informant confirms whether or not the control is carried out according to his or her intention. Incidentally, it is possible to confirm whether or not the publication control is carried out according to the intention by designating arbitrary date and time, for example, and causing to display the contents when assuming the present time is the designated date and time.

When the control is not carried out according to his or her intention, that is, the data whose publication should be controlled is displayed even if it is outside the valid period or the data whose publication should be controlled is not displayed even if it is within the valid period, the informant inputs an existence of a problem. The publication control setting program 72 accepts the input of the existence of the problem (step S31: No route), the processing returns to the step S23 via a terminal C, for example, to retry the processing. The processing may return to the step S25.

On the other hand, when the control is carried out according to his or her intention, the informant inputs no problem. The publication control setting program 71 accepts the input of no problem (step S31: Yes route), the processing shifts to step S33 via a terminal D, for example.

In addition, when the informant does not input the examination instruction at the step S27, it is assumed that an upload instruction is accepted in this embodiment. Therefore, the upload processor 722 uploads the publication data stored in the input text data storage 71 to the server 5 according to the upload instruction (step S33). As described above, the publication data includes the tagged data whose publication should be controlled and publication control condition data, and the data whose publication does not have to be controlled. The registration interface unit 51 of the server 5 carries out a processing necessary for the registration, such as the authentication of the informant terminal 7, and, then, receives the publication data from the informant terminal 7, and stores it into the publication data storage 53 (step S35).

By carrying out such a processing, the data as shown in FIG. 5C is uploaded to the server 5, and it becomes possible to carry out the publication control for a portion of the contents thereafter.

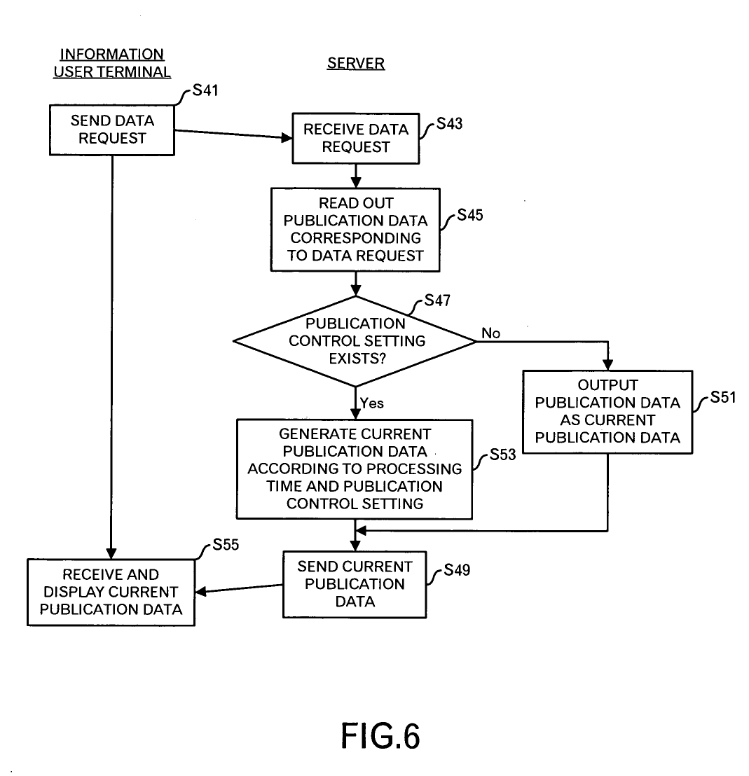

Next, a processing when receiving an access from the information user terminal 3 will be explained with reference to FIG. 6. The information user operates the information user terminal 3 to instruct the Web browser 31 to obtain the publication data by designating it (for example, uniform resource locator (URL)). Then, the Web browser 31 transmits a data request to the server 5 holding the publication data in response to the instruction from the information user (step S41). The reference interface unit 57 of the server 5 receives the data request from the information user terminal 3 (step S43), and outputs a request of the publication data relating to the data request to the publication controller 55. The publication controller 55 reads out the publication data relating to the data request from the publication data storage 53 (step S45), and judges whether or not a predetermined publication control setting is included in the publication data (step S47). In the examples of FIG. 3D and FIG. 5C, it is judges whether or not the <tel> tag that is a tag representing the inclusion of the data whose publication should be controlled is included.

When the publication control setting is not included in the publication data, the publication controller 55 outputs the publication data read out from the publication data storage 53 as it is the current publication data to the reference interface unit 56 (step S51). Then, the processing shifts to step S53.

On the other hand, when the publication control setting is included in the publication data, the publication controller 55 generates current publication data according to the publication control setting included in the processing time (that is, the present time) and the publication data (step S49). In the example of FIG. 3D, the publication controller 55 judges whether or not the processing time is within the valid period or the publication period of “2005/10/1-2005/10/3” that is the attribute value of the open attribute of the <tel> tag, and when it is within the valid period or the publication period, it generates the current publication data including a line of “Telephone Number: 044-xxx-xxx” (FIG. 3E) and the data whose publication does not have to be controlled. Specifically, it generates a hyper text markup language (HTML) file including such data, and stores the HTML file into a storage device such as a main memory. On the other hand, when the processing time is not within the valid period or the publication period of “2005/10/1-2005/10/3” that is the attribute value of the open attribute of the <tel> tag, it generates the current publication data including a line of “Telephone number:” (FIG. 3F), and the data whose publication does not have to be controlled, and stores the current publication data into the storage device such as a main memory.

In addition, in the example of FIG. 5C, the publication controller 55 judges whether or not the processing time is within the valid period or the publication period of “2005/9/8-2005/10/1” that is the attribute value of the open attribute of the <tel> tag, and when the processing time is within the valid period or the publication period, it generates the current publication data including a line of “Telephone number: 044-xxx-xxx” (FIG. 5D), and the data whose publication does not have to be controlled, and stored the current publication data into the storage device such as a main memory. On the other hand, when the processing time is not within the valid period or the publication period of “2005/9/8-2005/10/1” that is the attribute value of the open attribute of the <tel> tag, it generates the current publication data including a line of “Telephone number: We do not accept your contact now” (FIG. 5E) and the data whose publication does not have to be controlled, and stores the current publication data into the storage data such as a main memory.

Then, the publication controller 55 outputs the current publication data generated in the step S49 to the reference interface unit 57, and the reference interface unit transmits the current publication data to the information user terminal 7 of the requesting source (step S53). The Web browser 31 of the information user terminal 3 receives the current publication data from the server 5, and displays it on the display device (step S55). The display processing itself is not different from the normal display processing of the Web browser 31. Therefore, further explanation is omitted.

By carrying out the aforementioned processing, the publication control of the information is carried out according to the processing time of the server 5, that is, the time of the information utilization. More specifically, the data whose publication should be controlled is opened to the public as it is during the valid period of the data, and when the present time is outside the valid period, the data whose publication should be controlled is not opened to the public or other information is opened to the public.

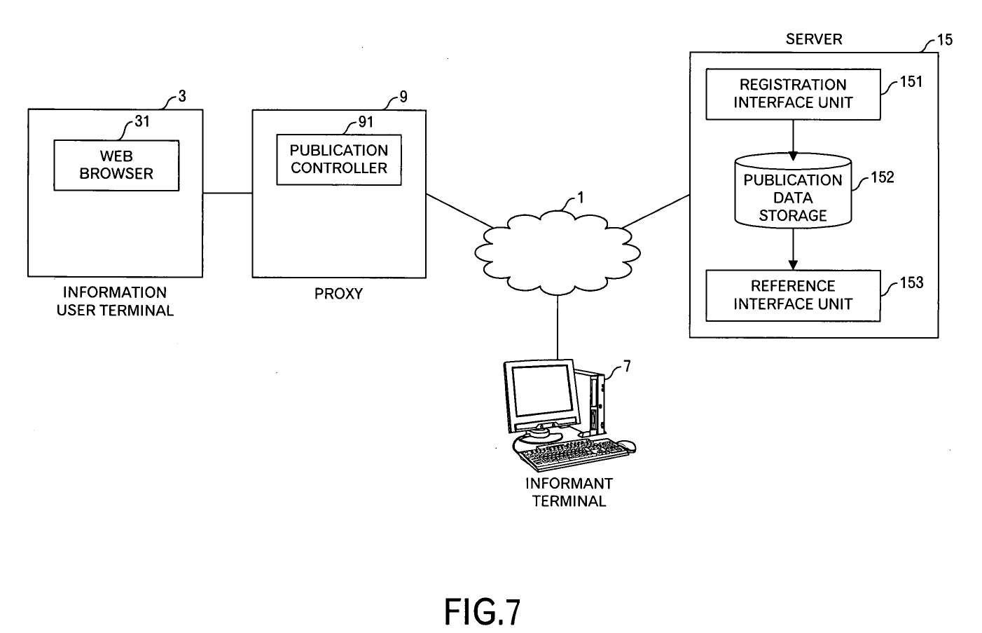

The aforementioned examples are mere examples, and it is possible to modify the embodiment of the present invention into various modes. For example, a system as shown in FIG.7 may be adopted. That is, the information user terminal 3 is connected to the network 1 via a proxy 9, and the proxy 9 has a publication controller 91 having the same function as that of the publication controller 55 provided in the server 5 in FIG. 1. On the other hand, a server 15 on behalf of the server 5 has a registration interface unit 151 having the same function as that of the registration interface unit 51 in the server 5, a publication data storage 152 having the same function as that of the publication data storage 53, and a reference interface unit 153 that simply reads out requested publication data from the publication data storage 152 in response to the request of the publication data from the network 1, and replies the read publication data. That is, the server 15 has only the same functions as that of the normal Web server. In addition, the informant terminal 7 is the same as the informant terminal 7 in FIG. 1.

In such a configuration, the generation of the publication data is the same as the aforementioned example. However, because the server 15 has only the same functions as those of the normal Web server, the publication data (FIG. 3D or FIG. 5C) requested by the information user terminal 7 is transmitted from the server 15 via the network 1 as it is. Then, when the publication controller 91 of the proxy 9 receives the publication, it judges whether or not the publication data includes the publication control setting, and generates data corresponding to the current publication data by carrying out the similar processing to the step S49 for the publication data including the publication control setting, and transmits the generated data to the information user terminal 3 of the requesting source. The Web browser 31 of the information user terminal 3 receives the current publication data from the proxy 9, and displays it on the display device. That is, this is a configuration in which the proxy 9 is introduced.

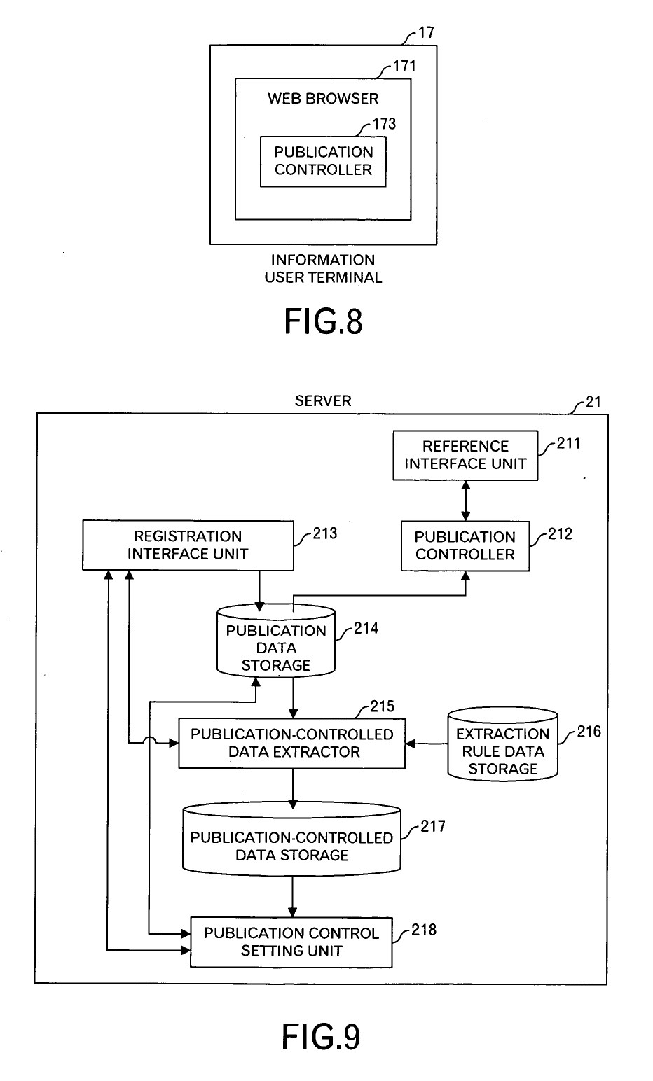

In addition, in the system shown in FIG. 7, an information user terminal 17 as shown in FIG. 8 may be connected to the network 1 not through the proxy 9. The information user terminal 17 has a Web browser 171. This Web browser 171 includes a publication controller 173 that carries out the similar processing to the step S49 as an additional function or a plug-in program, for example. In this way, the publication data (FIG. 3D or FIG. 5C) requested by the information user terminal 17 reaches the information user terminal 17, and the publication controller 173 of the Web browser 171 generates the current publication data (for example, HTML file) and displays it on the display device by the normal function of the Web browser 171.

Furthermore, when the informant terminal 7 does not have the publication control setting program 72, and has the document creation program, the input text data storage 71 and the Web browser, the server 5 may be replaced with a server 21 as shown in FIG. 9, for example. This server 21 has a reference interface unit 211 having the same function as that of the reference interface unit 57 of the server 5, a publication controller 212 having the same function as that of the publication controller 55 of the server 5, a registration interface unit 213 that communicates data with the Web browser of the informant terminal, a publication data storage 214 that stores text data generated by the document creation program in the informant terminal and received from the informant terminal and publication data generated in the server 21, a publication-controlled data extractor 215 that carries out the similar processing as that of the publication-controlled data extractor 723 of the publication control setting program 72 for the text data stored in the publication data storage 214, an extraction rule data storage 216 storing the same data as that of the extraction rule data storage 724 of the publication control setting program 72, a publication-controlled data storage 217 having the same function as that of the publication-controlled data storage 725 of the publication control setting program 72, and a publication control setting unit 218 that has the same function as that of the publication control setting unit 726 of the publication control setting program 72. In such a configuration, the aforementioned publication control setting can be carried out in the server 21 even if the informant terminal does not have any special functions.

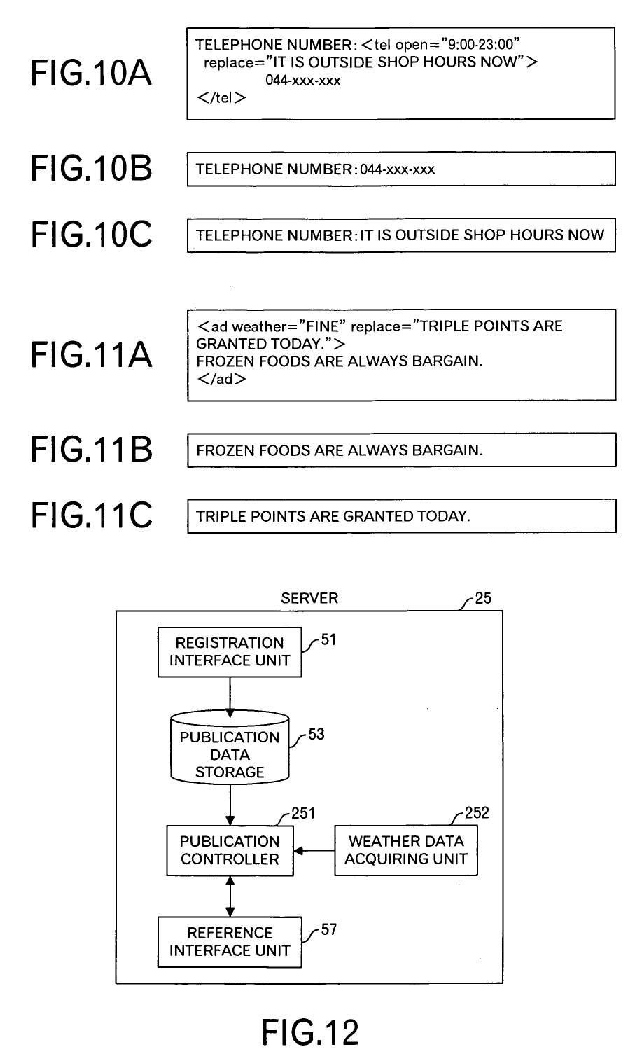

In addition, an application range of this embodiment is not limited to the contents to notify the event as indicated above. For example, the present invention can be applied to the display of the telephone number according to shop hours. For example, the publication data as shown in FIG. 10A is stored in the publication data storage 53. That is, the data whose publication should be controlled is the telephone number “044-xxx-xxx”, which is not changed. However, the time range “9:00-23:00” within one day, which indicates the shop hours, is designated as an attribute value of the open attribute, and “It is outside shop hours now” is designated as an attribute of the replace attribute. Therefore, when the present time is within the shop hours “9:00-23:00”, “Telephone number: 044-xxx-xxx” is displayed as shown in FIG. 10B, and when the present time is outside the shop hours, “It is outside shop hours now” is displayed as shown in FIG. 10C.

Although it is a similar example, as for the contact telephone number for the operation support of a computer system, another telephone number of the night support contact point may be displayed instead of “It is outside shop hours now”.

Furthermore, not only the telephone number, but also a lunch menu may be displayed daytime, and a dinner menu may be displayed at night.

In addition, as for personal homepages, when the birthday is set to the publication control condition data, and special information for the birthday is set to data whose publication should be controlled, the special information is displayed when the homepage is accessed on the birthday.

Furthermore, also on a page of a supermarket, this embodiment can be applied to a case where different articles for special sale or different services are displayed depending on the weather (fine or raining). For example, the publication data as shown in FIG. 11A is prepared. That is, “frozen foods are always bargain” is designated as data whose publication should be controlled, and “fine” is set as an attribute value of a weather attribute in an ad tag for the data whose publication should be controlled, and “triple points are granted today” is set as an attribute value of the replace attribute. In such a case, when accessing the page of the supermarket, “frozen foods are always bargain” as shown in FIG. 11B is displayed when it is fine near the supermarket, and “triple points are granted today” as shown in FIG. 11C is displayed when it is raining, for example.

In order to carry out such displays, a server 25 as shown in FIG. 12 is used instead of the server 5, for example. That is, the server 25 includes, similarly to the server 5, the registration interface unit 51, the publication data storage 53, and the reference interface unit 57, and further includes a weather data acquiring unit 252 to obtain the weather information from a weather information delivery server connected to the network 1, and a publication controller 251 to judge whether or not the publication control condition is satisfied, based on the information from the weather data storage 252. By this configuration, it becomes possible to obtain the weather data for an area near the supermarket, which is an origin of the registration of the publication data, to carry out the publication control.

Incidentally, the weather information in such a case is considered as one node of the publication control condition. However, it is also considered as the definition of the valid period for the data whose publication should be controlled. That is, the valid period for the data whose publication should be controlled is not only directly defined, but also indirectly defined. The condition to indirectly define the valid period can be another condition other than the weather, such as an operation state (operating or suspending) of a specific train.

In addition, in association with the weather information, the guidance information may be displayed when it is fine, and the postponement information may be displayed when it is raining, on a page for the event notification. In this way, the valid period of the data whose publication should be controlled is indirectly designated by the weather.

In addition, the application fields of the present invention innumerably exists, and not only publication/concealment/replacement, but also the change of the publication order can be implemented. Furthermore, there is a case where plural character strings whose publication should be controlled are defined on one page. In addition, for one place to be controlled in the publication, plural sets of the data whose publication should be controlled and the publication control condition data maybe defined. Moreover, in the aforementioned examples, the character string whose publication should be controlled such as the telephone number (<tel>) and the character string representing the publication information such as the event period (<openMarker>) and the character string of the publication control condition such as the date (<date>) are embedded into the text. However, such a mode of this embodiment is a mere example, and it is possible to manage the aforementioned information outside the text. Such a case can be realized by preparing data holding the position where the aforementioned information appears in the text, separately. In addition, in the aforementioned examples, “openMarker ” that is an attribute to indicate the relation to the publication condition, “open” that is an attribute concerning the publication condition according to the date or time, and “replace” that is an attribute to designate the replaced character string are fixedly used. However, by defining new attribute names and their meanings of the attribute names for the publication condition designation and the replaced character string destination, it is possible to change the attribute names if necessary. In the embodiment of the publication control using the weather, “weather” to designate the publication condition is used on behalf of “open”.

Incidentally, the aforementioned functional blocks do not always correspond to actual program modules.

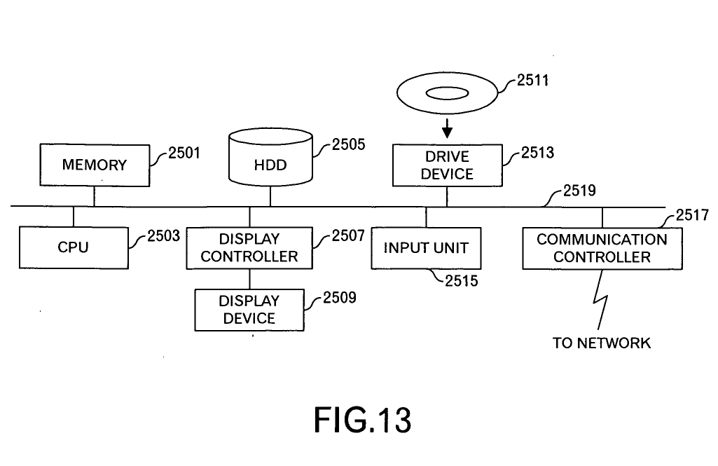

In addition, the server, the informant terminal, the information user terminal and the proxy are computer devices as shown in FIG. 13. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. An information publication control method, comprising:
reading out publication data including first data whose publication should be controlled, publication control condition data relating to a valid period of said first data, and second data whose publication does not have to be controlled from a publication data storage storing said publication data to judge whether or not a condition defined in said publication control condition data is satisfied; and
upon detecting that said condition defined in said publication control condition data is satisfied, generating current publication data including said first data corresponding to said publication control condition data whose condition is judged to be satisfied and said second data, and outputting the generated current publication data.

2. The information publication control method as set forth in claim 1, further comprising:
extracting a character string whose publication should be controlled from text data to be published, which is designated by an informant.

3. The information publication control method as set forth in claim 2, wherein said extracting comprises extracting a character string corresponding to personal information including a unique noun or information to which a valid period can be set, from said text data.

4. The information publication control method as set forth in claim 2, further comprising:
presenting the extracted character string as candidate data to said informant; and
identifying a candidate character string selected by said informant or a character string designated by said informant as said first data in said publication data.

5. The information publication control method as set forth in claim 2, further comprising:
extracting a publication control condition character string corresponding to said first data from said text data to be published.

6. The information publication control method as set forth in claim 5, wherein said extracting said publication control condition character string comprises:
extracting a predetermined type of second character string or a second character string representing a valid period from said text data to be published, said second character string having a degree of association, which is equal to or more than a predetermined threshold, with the extracted character string whose publication should be controlled.

7. The information publication control method as set forth in claim 5, further comprising:
presenting the extracted publication control condition character string as candidate data to said informant; and
identifying candidate data selected by said informant or data designated by said informant as said publication control condition data in said publication data.

8. The information publication control method as set forth in claim 4, further comprising:
generating said publication data by assigning a tag for publication control so as to associate the identified first data with said publication control condition data.

9. The information publication control method as set forth in claim 2, wherein said text data to be published is text data having no structure in data itself.

10. The information publication control method as set forth in claim 2, wherein said first data and said second data are mixed in said text data to be published.

11. The information publication control method as set forth in claim 1, wherein said publication data includes a plurality of sets of said first data and said publication control condition data for said first data, and
said generating further comprises:
generating current publication data including said first data and said second data for one set of said plurality of sets, said one set relating to said publication control condition data whose condition is judged to be satisfied.

12. An information publication control instruction method, comprising:
extracting a character string whose publication should be controlled from text data to be published, which is designated by an informant;
presenting the extracted character string as publication controlled candidate data to said informant;
identifying said publication controlled candidate data selected by said informant or data designated by said informant as first data whose publication should be controlled;
extracting a publication control condition character string corresponding to said first data and relating to a valid period from said text data to be published;
presenting the extracted publication control condition character string as condition candidate data to said informant;
identifying said condition candidate data selected by said informant or data designated by said informant as publication control condition data;
assigning a tag for publication control so as to associate said first data with said publication control condition data, and generating publication data including data whose publication does not have to be controlled and which is included in said text data and the tagged first data and publication control condition data.

13. A program embodied on a medium, for causing a computer to control information publication, said program comprising:
reading out publication data including first data whose publication should be controlled, publication control condition data relating to a valid period of said first data, and second data whose publication does not have to be controlled from a publication data storage storing said publication data to judge whether or not a condition defined in said publication control condition data is satisfied; and
upon detecting that said condition defined in said publication control condition data is satisfied, generating current publication data including said first data corresponding to said publication control condition data whose condition is judged to be satisfied and said second data, and outputting the generated current publication data.

14. A program embodied on a medium, said program comprising:
extracting a character string whose publication should be controlled from text data to be published, which is designated by an informant;
presenting the extracted character string as publication controlled candidate data to said informant;
identifying said publication controlled candidate data selected by said informant or data designated by said informant as first data whose publication should be controlled;
extracting a publication control condition character string corresponding to said first data and relating to a valid period from said text data to be published;
presenting the extracted publication control condition character string as condition candidate data to said informant;
identifying said condition candidate data selected by said informant or data designated by said informant as publication control condition data;
assigning a tag for publication control so as to associate said first data with said publication control condition data, and generating publication data including data whose publication does not have to be controlled and which is included in said text data and the tagged first data and publication control condition data.

15. An information publication control apparatus, comprising:
a unit that reads out publication data including first data whose publication should be controlled, publication control condition data relating to a valid period of said first data, and second data whose publication does not have to be controlled from a publication data storage storing said publication data to judge whether or not a condition defined in said publication control condition data is satisfied; and
a unit that generates, upon detecting that said condition defined in said publication control condition data is satisfied, current publication data including said first data corresponding to said publication control condition data whose condition is judged to be satisfied and said second data, and outputs the generated current publication data.

16. An information publication control instruction apparatus, comprising:
a unit that extracts a character string whose publication should be controlled from text data to be published, which is designated by an informant;
a unit that presents the extracted character string as publication controlled candidate data to said informant;
a unit that identifies said publication controlled candidate data selected by said informant or data designated by said informant as first data whose publication should be controlled;
a unit that extracts a publication control condition character string corresponding to said first data and relating to a valid period from said text data to be published;
a unit that presents the extracted publication control condition character string as condition candidate data to said informant;
a unit that identifies said condition candidate data selected by said informant or data designated by said informant as publication control condition data;
a unit that assigns a tag for publication control so as to associate said first data with said publication control condition data, and generates publication data including data whose publication does not have to be controlled and which is included in said text data and the tagged first data and publication control condition data.
